(19) United States
(12) Patent Application Publication
(10) Pub. No.: US 2004/0182026 A1
(43) Pub. Date: Sep. 23, 2004

(54) Brick and stone facings

(76) Inventor: Cameron J.R. Clarke, Wick Low (IL)

Correspondence Address: JACOBSON HOLMAN PLLC, 400 SEVENTH STREET N.W., SUITE 600, WASHINGTON, DC, 20004, US

(21) Appl. No.: 10/735,813

(22) Filed: Dec. 16, 2003

Related U.S. Application Data
(63) Continuation of application No. PCT/IE02/00083, filed on Jun. 25, 2002.

(30) Foreign Application Priority Data
Jun. 25, 2001 (IE) S2001/0583

(51) Int. Cl. B28B 1/14; B28B 1/16; B28B 7/36; B29C 33/40; E04C 1/00

(52) U.S. Cl. 52/315; 264/333; 264/338; 264/233; 264/256; 264/219; 52/311.1

(57) ABSTRACT

A constructional panel 1 has a facing 3 which is brick or stone-like with mortar joints 4 therebetween and a backing 2 of cementitious material. The panel is cast using a mould mat 20 and a mask 30. The mat 20 is formed from a built panel and the mask 30 is formed from the 20. The mask 30 is used to provide realistic mortar joints between the facing elements 3.

The invention relates to constructional elements such as building panels, walling, pillars, kerbing, paving and the like.

Pointed brick and stone products are expensive to produce and considerable skill and time is required to construct a wall or pave an area using such products. In an effort to avoid these problems various attempts have been made to produce “artificial” products which have facings of expensive material but using less expensive base materials. In general such products are not satisfactory either because they are difficult to make and or do not achieve the same aesthetic effect as conventional products. There is therefore a need for improved constructional elements, which are relatively cheap and easy to produce and yet achieve the aesthetic effect of pointed brick, stone and the like.

### STATEMENTS OF INVENTION

According to the invention there is provided a method for manufacturing a constructional panel comprising the steps of:

providing a mould mat comprising a plurality of ribs, the ribs defining recesses therebetween and the ribs having upper surface contours;

placing a mask on the mould mat ribs to substantially cover at least the upper surface of the ribs;

casting a cementitious material in the mould; and

removing the cast panel thus formed from the mould.

The ribs may be raised ribs to provide recessed pointing or may be recessed ribs to produce raised pointing.

In one embodiment of the invention the method comprises the step of applying a force to substantially seal the mask to the upper surface of the ribs. The force may be a pressure force. Alternatively or additionally the force is a magnetic force. In this case the mould mat and/or the mask are at least partially magnetised. The mould mat and the mask may be at least partially of a magnetic material.

In one embodiment of the invention the method comprises applying a retarder to the mould mat, prior to casting a cementitions material in the mould. The retarder is preferably removed from the face of the panel, after casting, for example the retarder may be removed by washing.

In another embodiment the method comprises casting a facing material in the recesses of the mould mat prior to casting the cementitions material. The facing material may be a brick or brick-like material. The facing material may be of a cementitious material. The facing material may include a colouring agent. Preferably the method comprises the step of removing the mask prior to casting of the cementitious material.

In one case the mask is removed after application of a retarder.

In another case the mask is removed after casting of the facing.

The mask may comprise a masking tool. Alternatively, the mask comprises a grid.

In one embodiment of the invention the mould mat is manufactured by:

providing a mould box;

building a panel comprising a plurality of elements with joints therebetween in the mould;

applying a mould-forming material over the exposed face of the panel thus formed to form a mould mat; and

removing the mould mat from the mould, the mould mat having a plurality of ribs with an upper surface contour corresponding to the contour of the joints of the panel built in the mould box.

In one embodiment the mask is manufactured by:

applying a mask-forming material over the nibs of the mould mat; and,

removing the mask from the ribs.

Preferably the mask is formed from a flowable material.

In one embodiment the mask is formed by:

providing damming means around the ribs;

pouring the mask-forming material onto the ribs;

setting the mask-forming material;

removing the damming means; and

removing the formed mask from the ribs.

The invention also provides a panel when manufactured by a method of the invention.

In a further aspect the invention provides a method for manufacturing a mask for use in moulding a constructional panel comprising:

providing a mould mat having a plurality of ribs with an upper surface contour corresponding to the contour of jointing between constructional elements;

applying a mask-forming material onto the ribs of the mould mat; and

removing the mask from the ribs.

In one embodiment the mask is formed from a flowable material. The mask may be formed by:

providing damming means around the ribs;

pouring the mask-forming material onto the ribs;

setting the mask-forming material;

removing the damming means; and

removing the formed mask from the ribs.

The invention also provides a mask whenever manufactured by a method of the invention.

In a further aspect the invention provides a cast panel comprising a plurality of facing elements with a jointing between the facing elements, the panel having a defined interface between the facing elements and the jointing material, and the panel being substantially of cementitious material.

In one embodiment the facing elements are of brick or brick-like material.

The facing elements may be substantially of cementitious material. The facing elements may be treated to replicate a stone facing.

The invention also provides a method for casting a cementitious constructional element with a facing comprising the steps of:

placing a mould mat in a mould, the mould mat comprising a grid defining a plurality of recesses therebetween;

casting a facing material in the recesses of the mould mat;

casting a cementitious material to a desired thickness on top of the cast facing material; and

removing the cast panel thus formed from the mould.

In one embodiment the method includes the step after casting of the facing and prior to casting of the cementitious material, of placing an insert grid over the grid pattern of the mould mat. Preferably the insert grid is shaped to form recessed mortar joints in the cementitious material.

In a preferred embodiment the method includes the step of applying a retaining force to the insert grid to retain the retaining grid in a desired position during casting of the cementitious material. The retaining force may be applied by a spring bias from the retaining grid/cage. Alternatively the retaining force is applied by a positioning tool. Preferably the method includes the step of inserting the positioning tool into the mould to engage the insert grid and retain the grid in position during casting of the cementitious material.

In one embodiment the facing material is a brick or brick-like material. Alternatively the facing material is a cementitious material. The facing material may include a colouring agent.

In another embodiment the method comprises the step of inserting a masking tool to engage the grid pattern of the mould mat and withdrawing the masking tool prior to casting of the cementitious material.

In another aspect the invention provides a method for producing a stone-like effect with mortared joints. A masking tool is pressed against a mould mat to cover the areas which would correspond to mortared joints. A retarder is then applied to the remaining surface of the mould mat. The masking tool is removed, the retarder allowed to dry and the mould mat is placed in a mould box to produce a casting, typically of a cementitious material. After curing, water is applied to the face of the casting to expose the aggegate of the cementitious material thereby imitating stone. The mortared joints being of cured concrete retain their cementitious appearance to imitate mortar.

The invention also provides novel constructional elements especially when produced by a method of the invention.

The invention further provides novel casting apparatus especially for use in the methods of the invention.

### BRIEF DESCRIPTION OF THE DRAWINGS

The invention will be more clearly understood from the following description thereof given by way of example only, in which:

FIG. 1 is a perspective view of a mould for use in forming a mould mat of the invention;

FIG. 2 is a cross sectional view of the mould of FIG. 1;

FIG. 3 is a perspective view of the mould of FIGS. 1 and 2 illustrating first steps in a method for forming a mould mat according to the invention;

FIG. 4 is a cross sectional view of the mould mat of FIG. 3;

FIG. 5 is a perspective view of the mould of FIGS. 1 and 2 illustrating further steps in a method for forming a mould mat of the invention;

FIG. 5(a) is a perspective view of a mould illustrating steps in a method for forming an alternative mould mat;

FIG. 6 is a cross sectional view of the mould of FIG. 5;

FIG. 6(a) is a cross sectional view of the mould of FIG. 5(a);

FIG. 7 is a cross sectional view of portion of a finished mould mat;

FIGS. 8(a) to 8(d) illustrate steps in a method for forming a mask according to the invention;

FIG. 9 is a perspective view of the mask;

FIG. 10 is a perspective view of a mask being placed on a mould mat on a moulding table;

FIG. 10(a) is a perspective view of another mask being placed on a mould mat on a moulding table;

FIG. 11 is a cross sectional view of the assembled mask and mat of FIG. 10;

FIG. 12 is a cross sectional view of an enlarged seal of a joint between a mould mat and a mask;

FIG. 13 is a cross sectional view similar to FIG. 12 of an alternative joint;

FIG. 14 is a perspective view of the mask placed on a mould mat on the moulding table;

FIG. 14(a) is a perspective view of the mask and mould mat of FIG. 10(a) on a moulding table.

FIGS. 15 is a cross sectional view of the mould mat, mask and table assembly being used in a method for forming a stone faced panel;

FIG. 16 is a cross sectional view of the mould mat in a moulding box;

FIG. 17 is a plan view of a mould box with a number of mould mats;

FIG. 18 is a front view of a stone faced panel formed using the apparatus and method of the invention;

FIG. 19 is an enlarged view of a joint detail of the panel of FIG. 18;

FIG. 20 is a cross sectional view of an assembled mask and mat used in an alternative method of the invention;

FIG. 21 is a perspective view of the mask of FIG. 20;

FIG. 22 and 23 are enlarged cross sectional views illustrating alternative joints between a mat and mask;

FIGS. 24 and 25 are cross sectional views of the mould mat, being used in a method for forming a brick faced panel;

FIG. 26 is a perspective view of portion of a brick faced panel formed using the apparatus and method of the invention;

FIG. 27 is a cross sectional view illustrating the forming of a rounded end of a panel;

FIG. 28 is a perspective view illustrating the assembly of a pillar using the panels of the invention;

FIG. 29 is a cross sectional view illustrating apparatus used in a method for producing a constructional element;

FIGS. 30(a) to 30(c) are respectively plan, elevational and cross sectional views of a mould box forming part of the apparatus of FIG. 29;

FIGS. 31(a) to 31(c) are respectively plan, elevational and cross sectional views of a mould mat forming part of the apparatus of FIG. 29;

FIGS. 32(a) to 32(c) are respectively plan, elevational and cross sectional views of an insert grid forming part of the apparatus of FIG. 29;

FIGS. 33(a) to 33(c) are respectively plan, elevational and cross sectional views of a positioning tool forming part of the apparatus of FIG. 29;

FIG. 34 is an exploded cross sectional view of an apparatus used to produce constructional elements with an exposed aggregate stone-like effect;

FIG. 35 is an exploded cross sectional view of a mould mat and associated mortar mat;

FIG. 36 is a cross sectional view of the mould mat and mortar mat of FIG. 35 assembled with a backing material and facing material in place;

FIG. 37 is an exploded cross sectional view of a mould mat and a mortar mould channel mask;

FIG. 38 is a cross sectional view of the mould mat and mask of FIG. 37, assembled with a facing mix in place;

FIG. 39 is a cross sectional view illustrating a first step in another processing method of the invention;

FIG. 40 is a cross sectional view illustrating a second step in the method;

FIG. 41 is a cross sectional view illustrating a third step in the method;

FIG. 42 is a cross sectional view of a finished casting; and

FIG. 43 is a perspective view of the casting with a sectioned front face.

### DETAILED DESCRIPTION

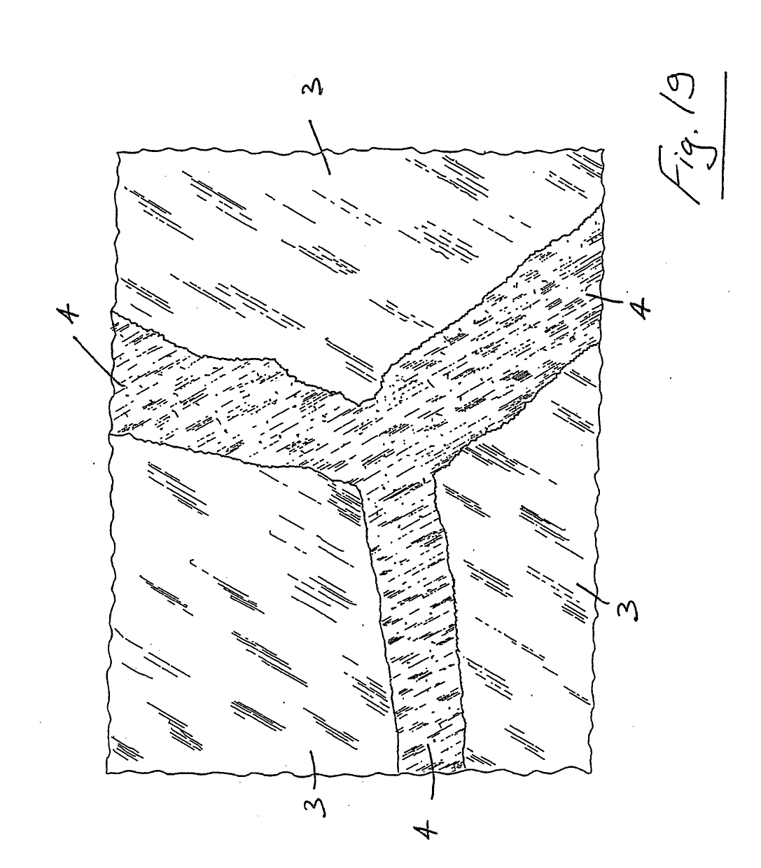

Referring to the drawings there is illustrated a constructional element according to the invention which in this case is in the form of a panel 1 comprising a backing 2 of cementitious material which is faced with a facing 3 simulating brick or stone with mortar joints 4 therebetween. By way of illustration in FIGS. 18, 19 and 26 elements having a number of brick-like or stone-like facings are shown however, the element may be of any desired shape or configuration and may contain one or several such facings in any desired pattern. The element may be used, for example, for masonry walling, paving and the like.

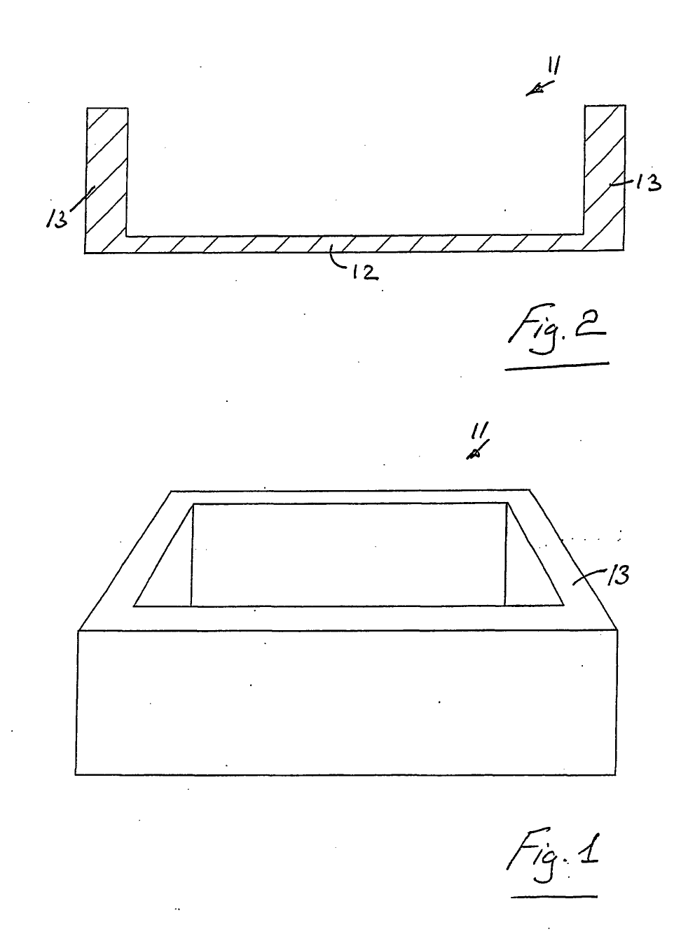

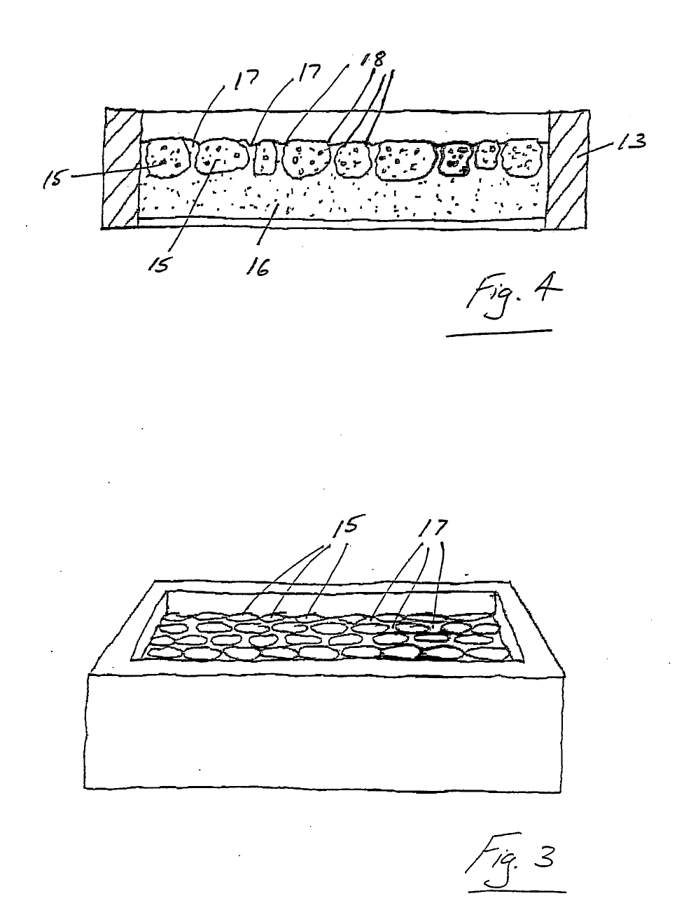

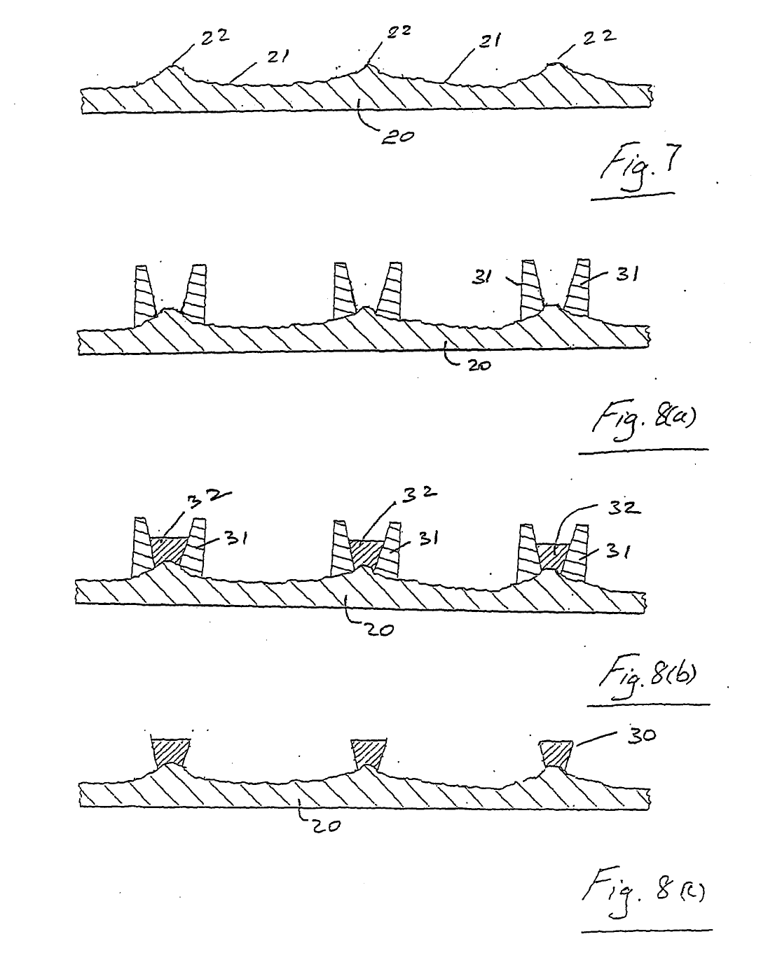

Referring initially to FIGS. 1 to 7 there is illustrated a method for manufacturing a mould mat 10 according to the invention. The method uses a mould box 11 having a base 12 and side walls 13. A panel in this case comprising a plurality of stone elements 15 is built in the box by first pouring in a cementitious material 16 and then facing the cementitious material 16 with the stone elements 15. The joints 17 between the adjacent elements 15 are formed in the same way as a cemential stone wall is built. On setting, a mould mat forming material such as liquid rubber is poured into the mould box 11 on top of the stone elements 15 and the joints 17. The liquid rubber takes up the contour of the stone elements 15 and the joints between them and on setting, a mould mat 20 is formed which has a face 21 which is a facsimile of the exposed faces of the stone elements 15 and a pattern of ribs 22 which are a facsimile of the contour and surface finish of the joints 17, including imperfections caused by brush strokes, used of pointing tools and the like. The mould 20 is therefore a facsimile of the front face of a built stone wall. Thus, the mould mat 20 can be used in producing a realistic panel which will have a front which not just mimics but is actually a facsimile of a conventionally built panel.

A marking such as a ink may be applied at the interface between the elements 15 and the mortar joints 17.

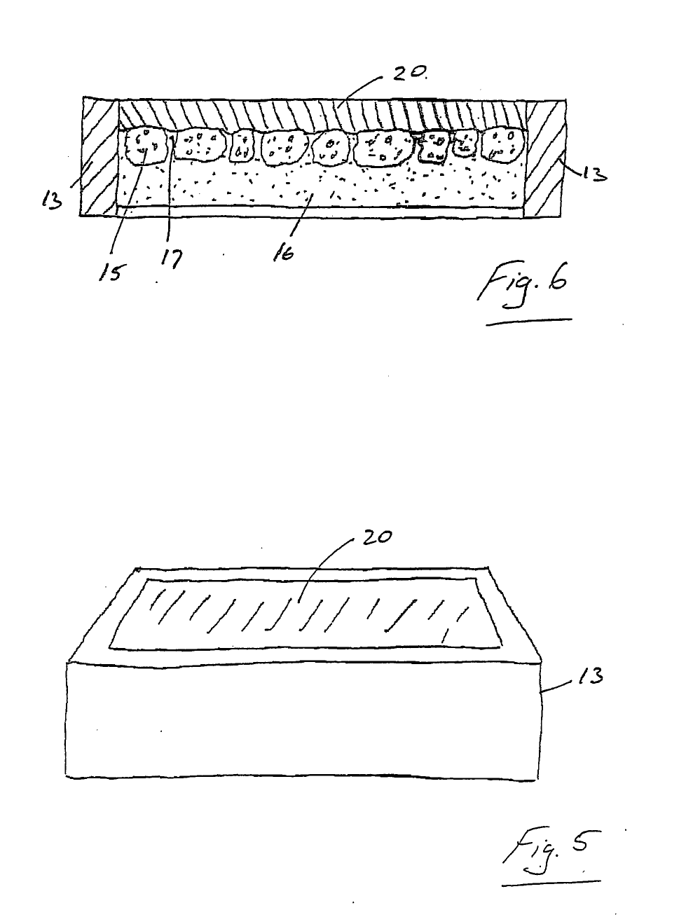

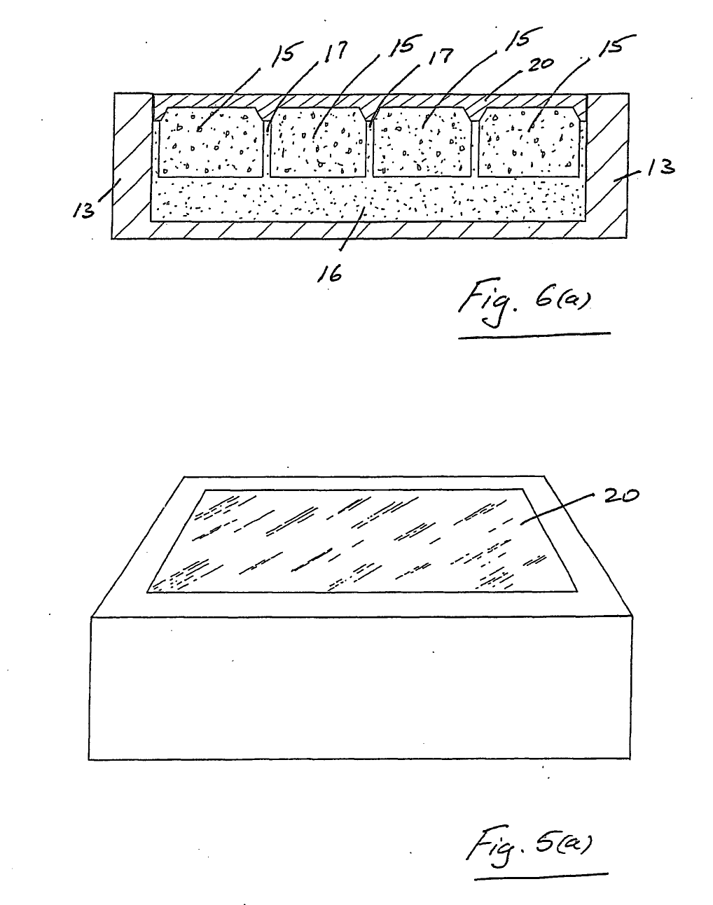

The elements 15 may be brick like elements as illustrated in FIGS. 5(a) and 6(a).

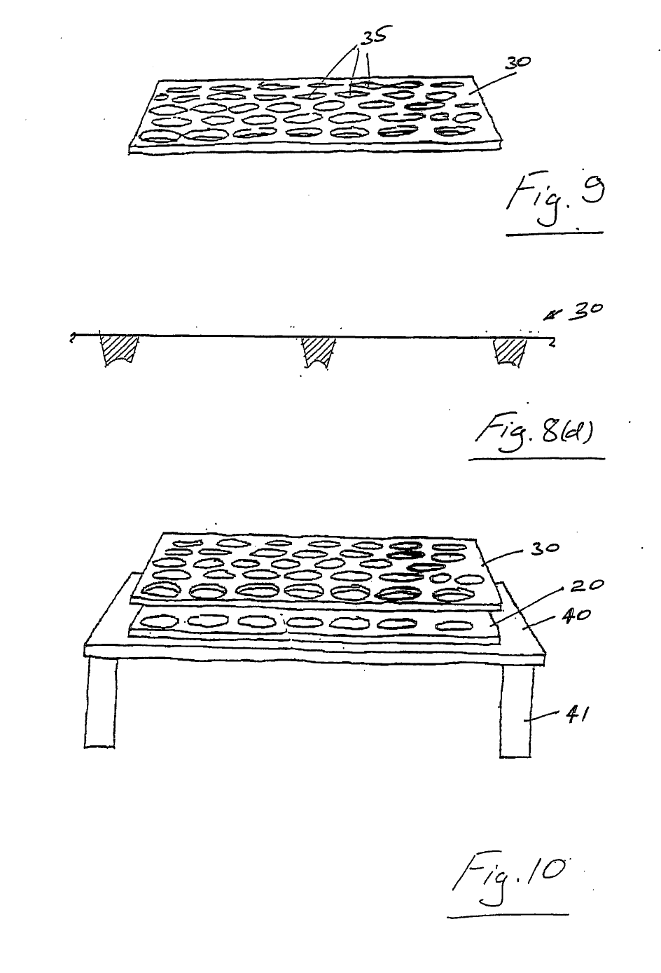

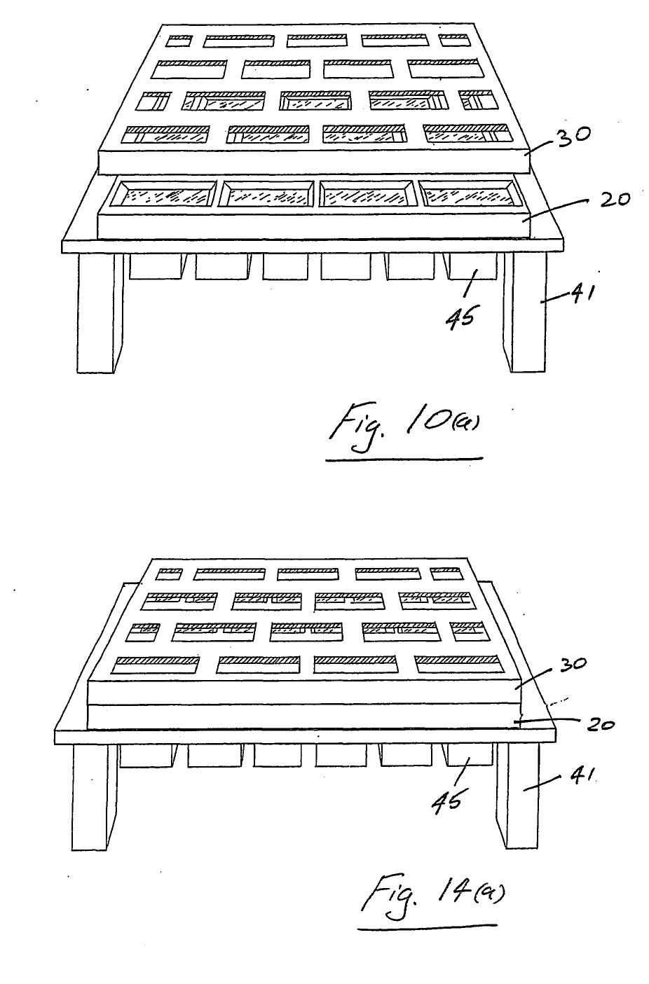

Referring now to FIGS. 8 and 9 there is illustrated steps in a method for manufacturing a mould mask 30 for use with the mould mat 20. To form the mask 30 the mould mat 20 is used. A mask forming material which may be a hot pour material or a cold material such as that available under the name RECKLI from RECKLI of Germany is used to form the mask with a front face which corresponds to the contour and surface finish of the raised ribs 22 of the mat 20. In this case damming 31 is mounted around the ribs 22 as illustrated in FIG. 8(a). The ink applied at the interface 18 between the element and the jointing transfers onto the mat 20 and provides added guidance for placement of the damming 31. Mould forming material 32 is applied into the ribs 22 and is confined by the damming 31 (FIG. 8(b)). On setting, the damming 31 is revelled (FIG. 8(c)) leaving the mould mask 30 in contact with the mould mat 20. The mask 30 is then removed (FIGS. 8(d), FIG. 9). The mask 30 comprises a body with a plurality of recesses 35 corresponding to the exposed faces 21 of the mould mat 20 between the ribs 22.

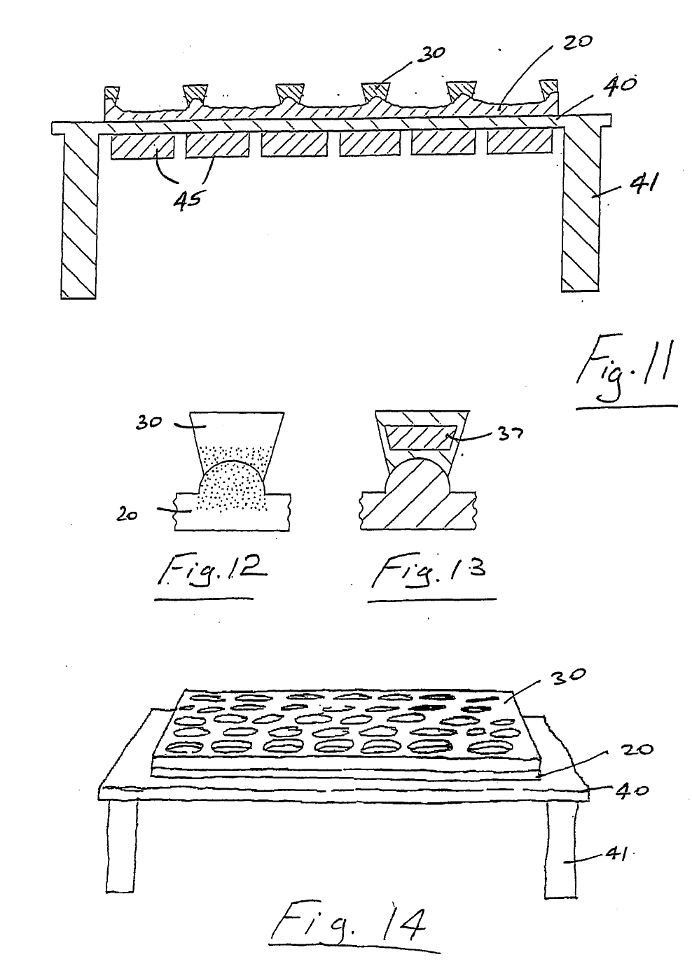

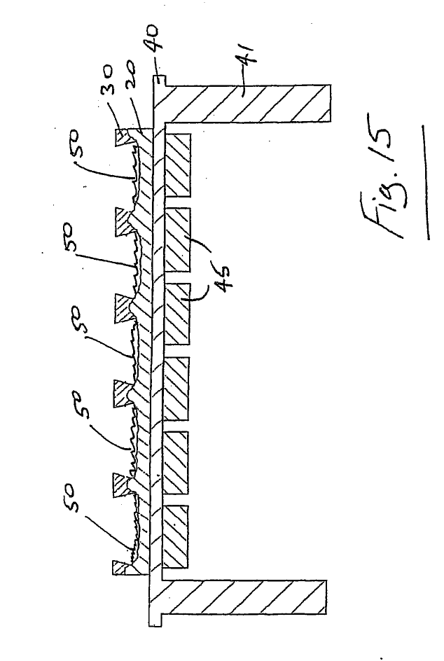

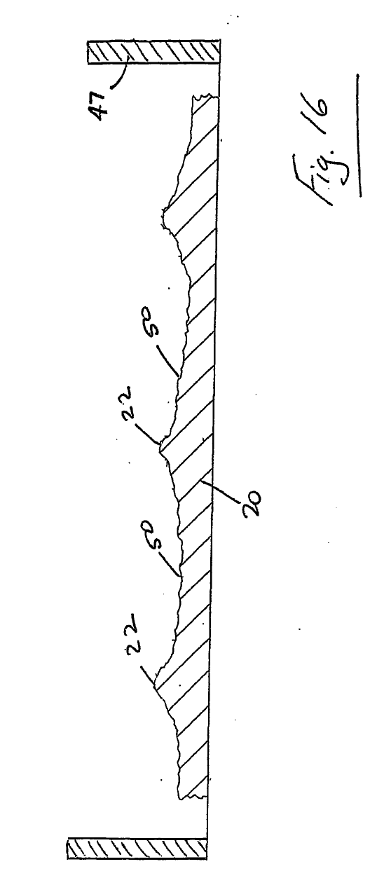

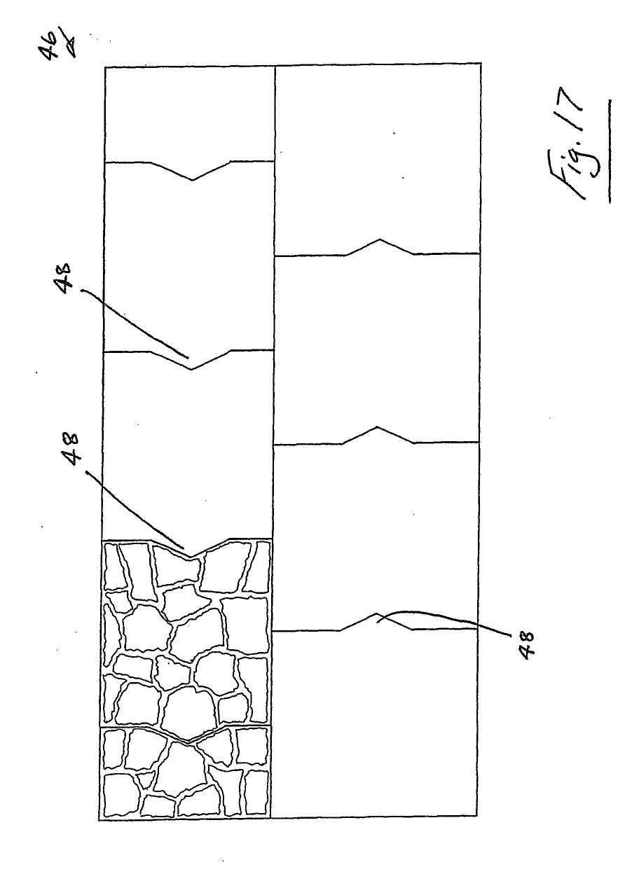

Referring to FIGS. 10 to 16, to manufacture a panel according to the invention a moulding table 40 is provided. The table 40 has supporting legs 41. The mould mat 20 is placed on the table 40 and the mould mask 30 is placed on top of the mould mat 20. Any suitable means may be used to force the mask 30 into engagement with the ribs 22 of the mould mat 20. Preferably a magnetic force is used. In this case, as illustrated in FIG. 12, the material used to form the mould mat 20 and the mask 30 has iron filings and strong magnets 45 are provided underneath the mould table 40 to draw the mask 30 into sealing engagement with the ribs 22 of the mat 20. Alternatively or additionally as illustrated in FIG. 13, the mask 30 may have magnetic strips 37 embedded therein. When the magnets 45 are activated the mask 30 is drawn into sealing engagement with the ribs 22 of the mould mat 20 as illustrated in FIGS. 11 and 14. On assembly of the mould mask 30 to the mould mat 20 in this case a retarding material 50 is first applied to the exposed faces 21 of the mould mat 20 through the recesses 35 in the mask 30 (FIG. 15). The mask 30 prevents the retarder 50 from covering the ribs 22 of the mould mat 20.

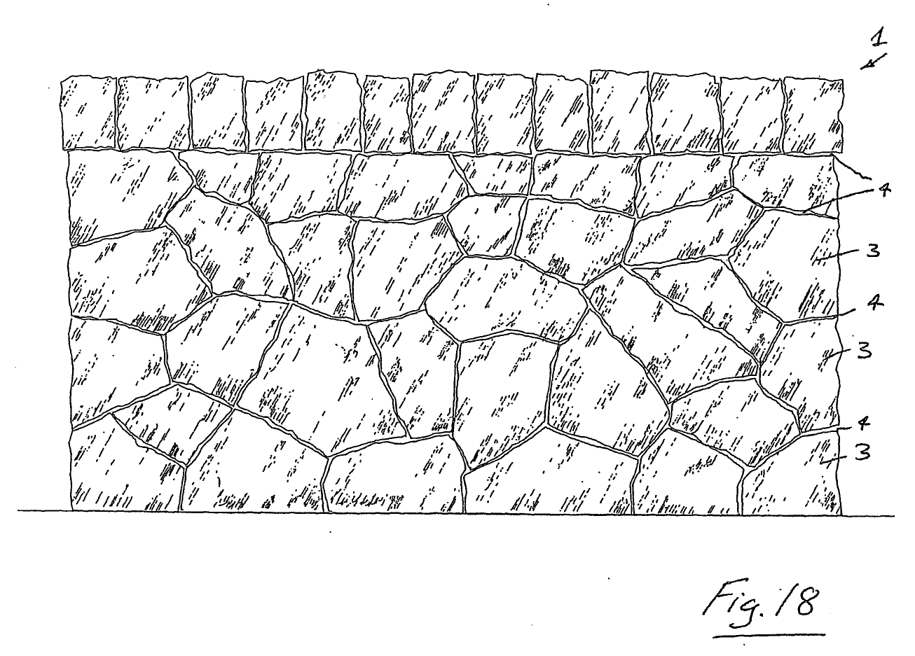

After application of the retarder, the mask 30 is removed from the mat 20 and the mat 20 is placed in a mould box 46 [FIG. 16]. A number of mould mats 20 may be placed in a mould box 46 as illustrated in FIG. 17. This arrangement facilitates large scale production. The joint between adjacent mould mats in the mould box 46 may have tongue and groove features 48 to break up the vertical lines. The mould box 46 illustrated in FIG. 17 may be used particularly for forming a large wall panel or the like. A cementitious material 55 is then poured into the mould box 46. On setting, a panel is formed comprising the cementitious material with a retarder 50 applied across the panel except at the joint regions defined by the ribs 22. The retarder is then, washed off and the cementitious material between the joints gives the appearance of a stone facing. The joint regions however are a facsimile of the joints in a cementionlly built panel as represented by the ribs 22 of the mould mat 20. The finished panel is illustrated in FIG. 18 and 19. The panel has a defined interface between the facing elements and the jointing material which is a facsimile of a conventionally built panel.

Referring now to FIGS. 20 to 25 there is illustrated an alternative method of the invention which is used in this case to form a panel 1 (FIG. 26) comprising a plurality of brick-like elements 3 with mortar joints 4 therebetween. The method is similar to that described alone and like parts are assigned the same reference numerals. In this case the mask 30 is provided with a support grid 65 of metal or the like and a face mix 66 is poured into the recesses of the mask 30. The face mix 66 may be of any suitable material, depending on the panel type required. For example, the face mix 66 may be a cementitious material with a colorant or other additives or may be at least partially of a brick or brick-like material. After forming of the facing 3 as illustrated in FIG. 20, the mask is removed (FIG. 24) and a backing layer 2 typically of cementitious material is poured over the facing 3 in a mould (FIG. 25).

Referring to FIG. 22 there is illustrated a joint between the mask 30 and rib 22 of the mat 20. It will be noted that the mask is cut-away at 69 to provide enhanced sealing engagement between the mask 30 and the rib 22 to substantially prevent leakage of facing material onto the rib 22. An alternative construction is illustrated in FIG. 23 in which the mask 30 is weighted into sealing engagement by a block 68.

Referring to FIG. 27 there is illustrated a method for forming a panel with a curved edge, for example for use as a finishing edge at a side or top of a panel. The method and apparatus is as described above except that in this case a filler piece 80 is provided in the mould, causing the facing to assume in this case a curved profile.

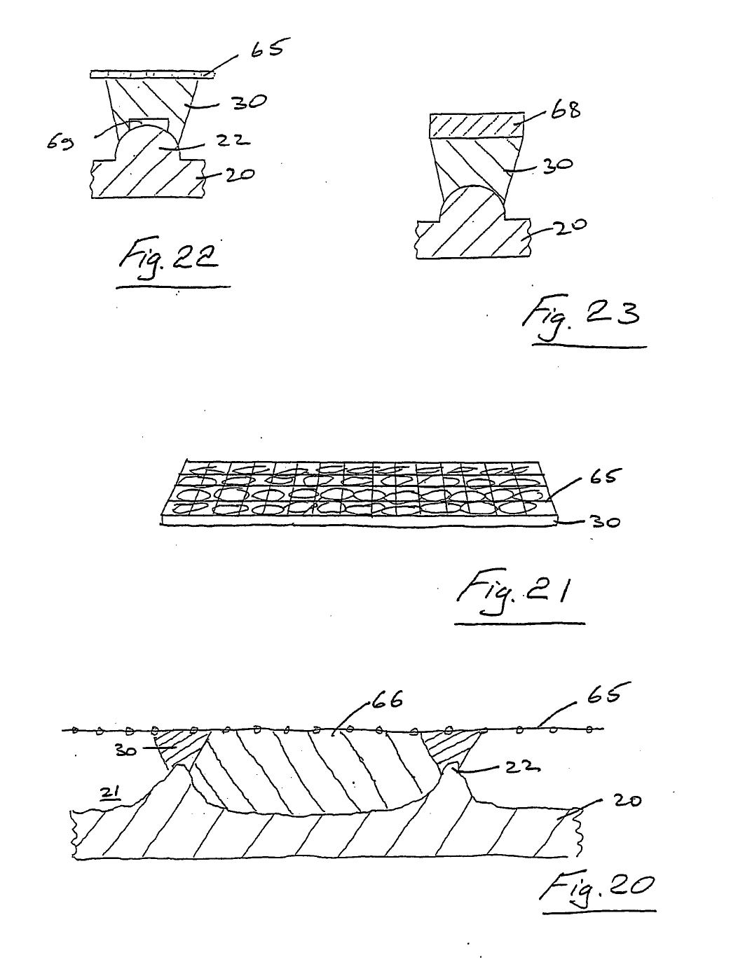

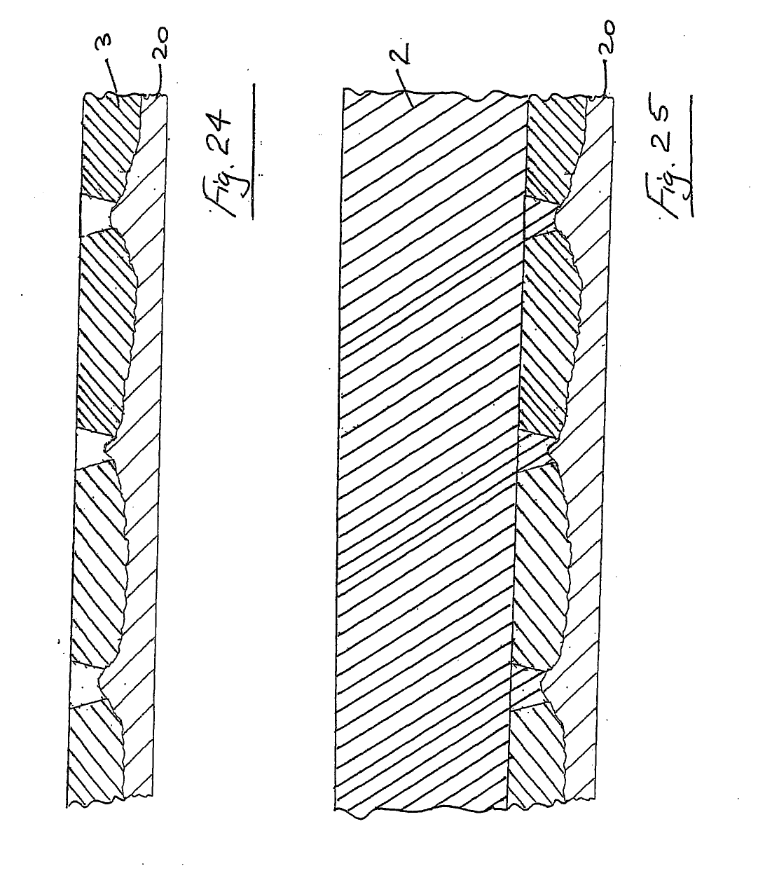

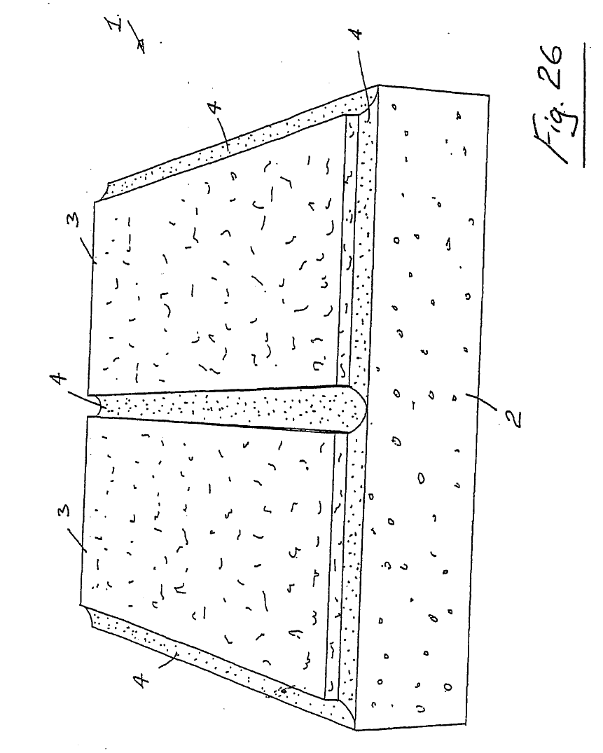

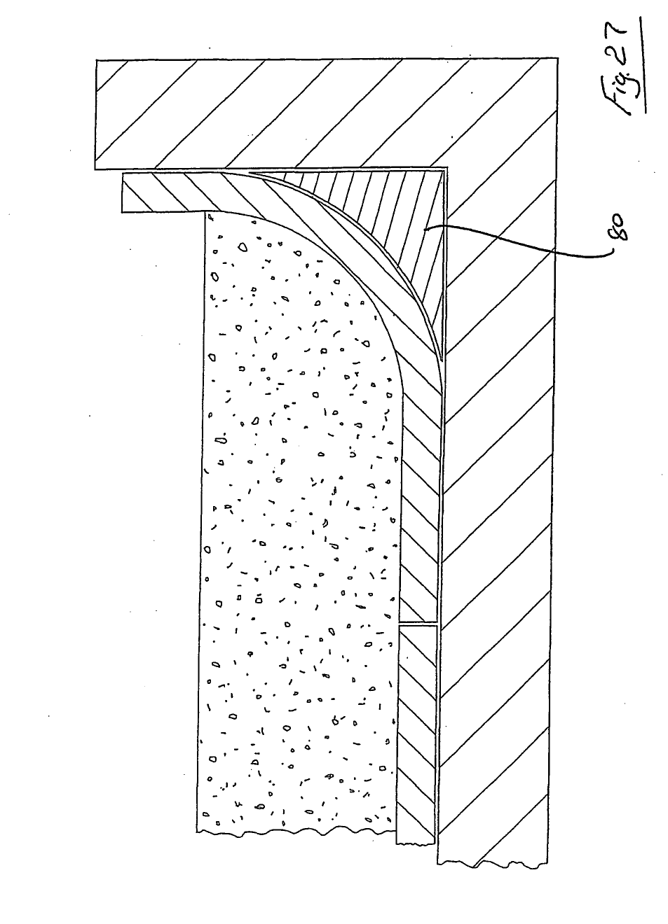

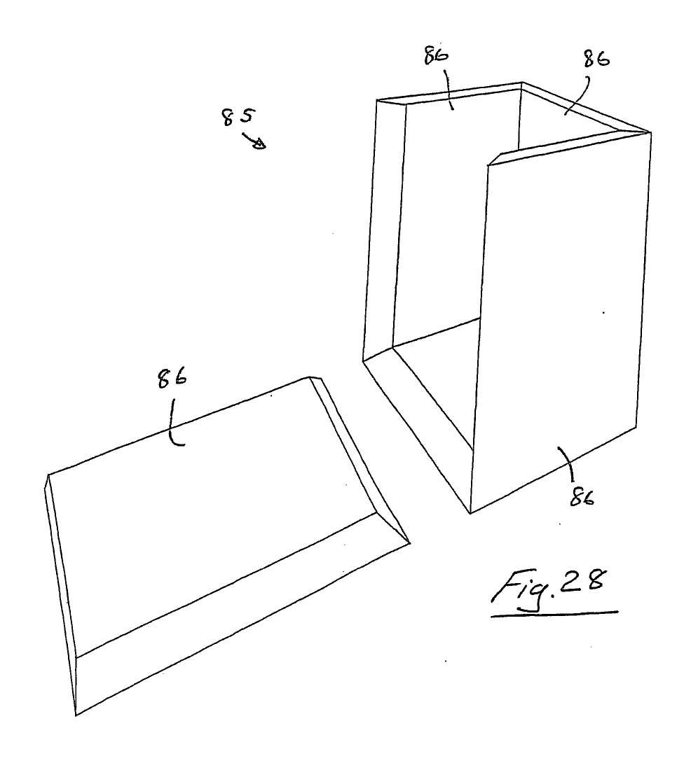

Referring to FIG. 28 there is illustrated a pillar 85 constructed from a number of panels 86 of the invention. The panels have mitred edges which may be formed as described above with reference to FIG. 27.

It will be noted that the invention involves direct casting from a mortared joint of a masking mould. This gives a totally realistic texturing to the finished casting.

Iron filings are incorporated into the rubber mould and mask to enhance the magnetic effect. Magnetism, particularly using neodymium iron boron magnets is used because they can operate through a considerable air space.

Metal sheet or mesh embedded or glued to mortar mask gives maximum pull from magnet and imparts dimensional stability. Conceivably a metal casting could be taken and used on the complete mask. This would be particularly suitable from a production point of view.

Preferably a weight is used to hold down the mask.

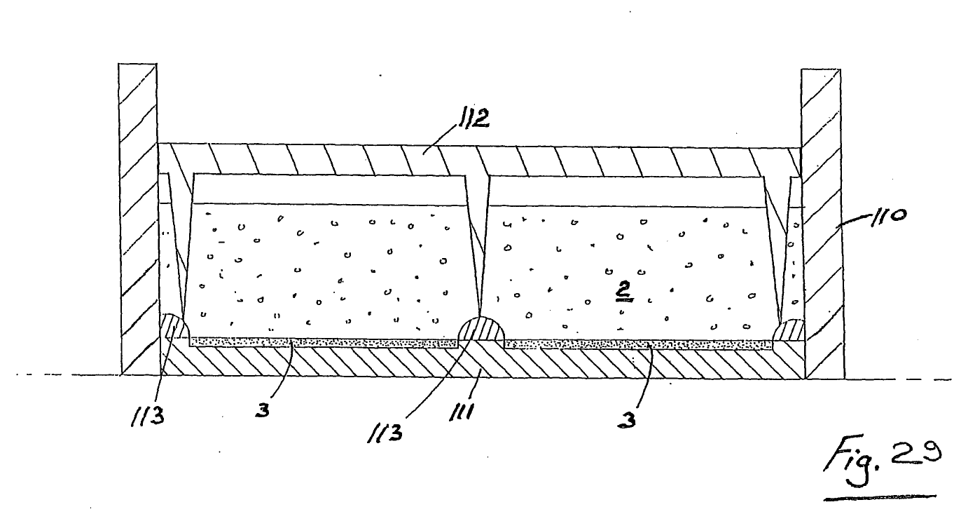

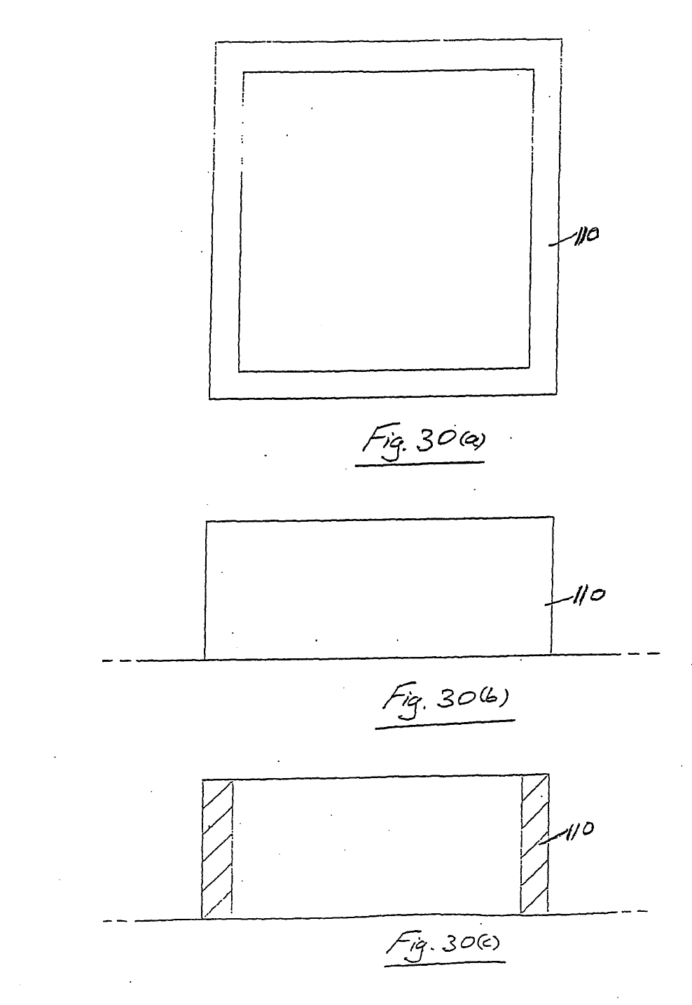

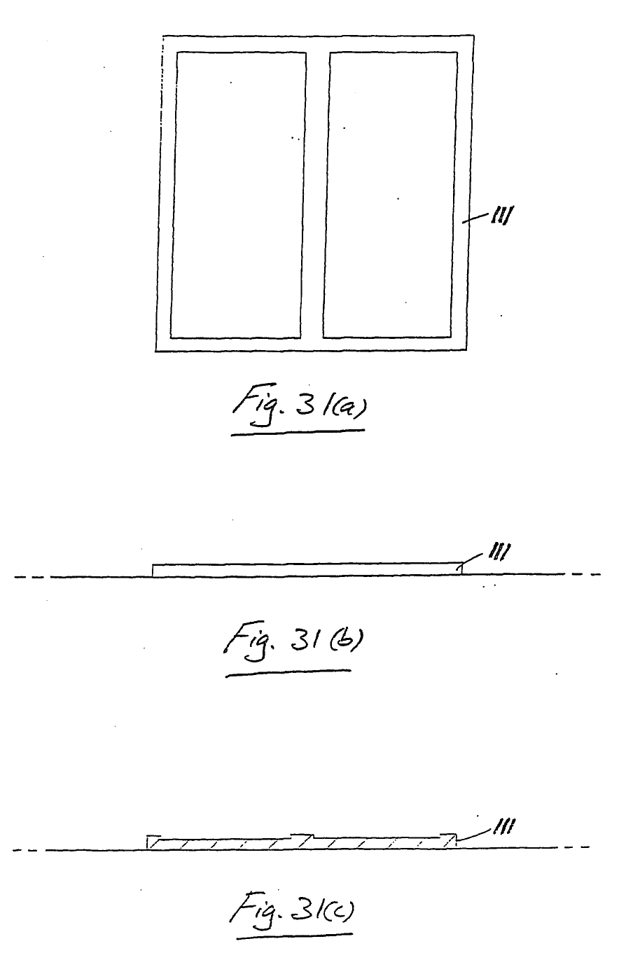

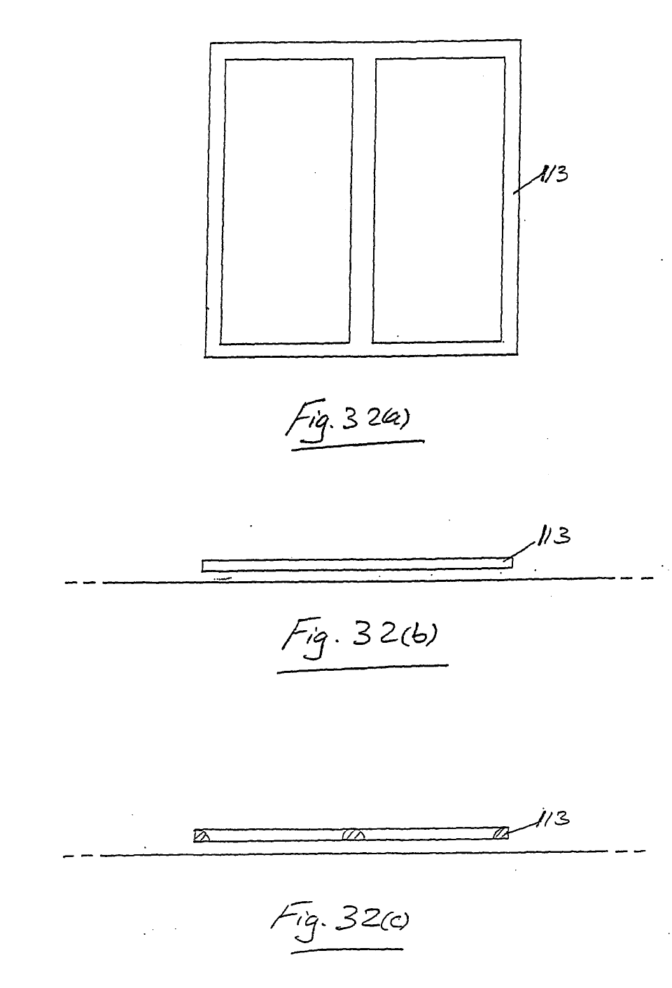

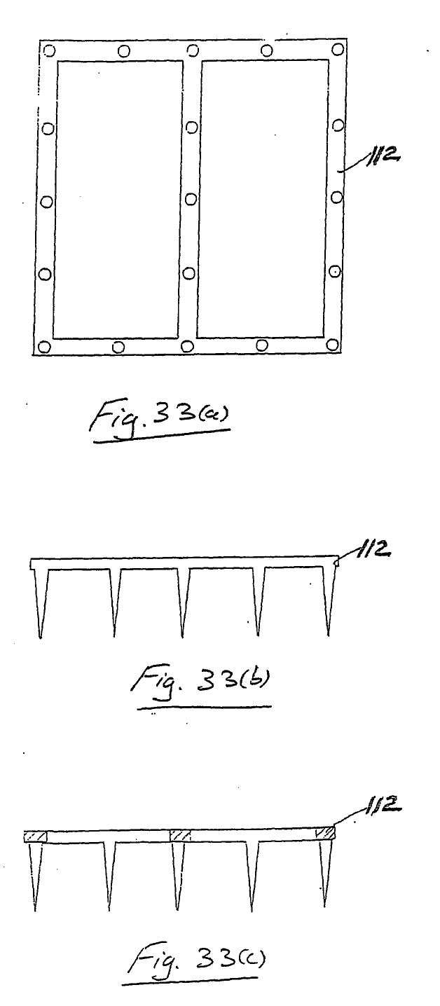

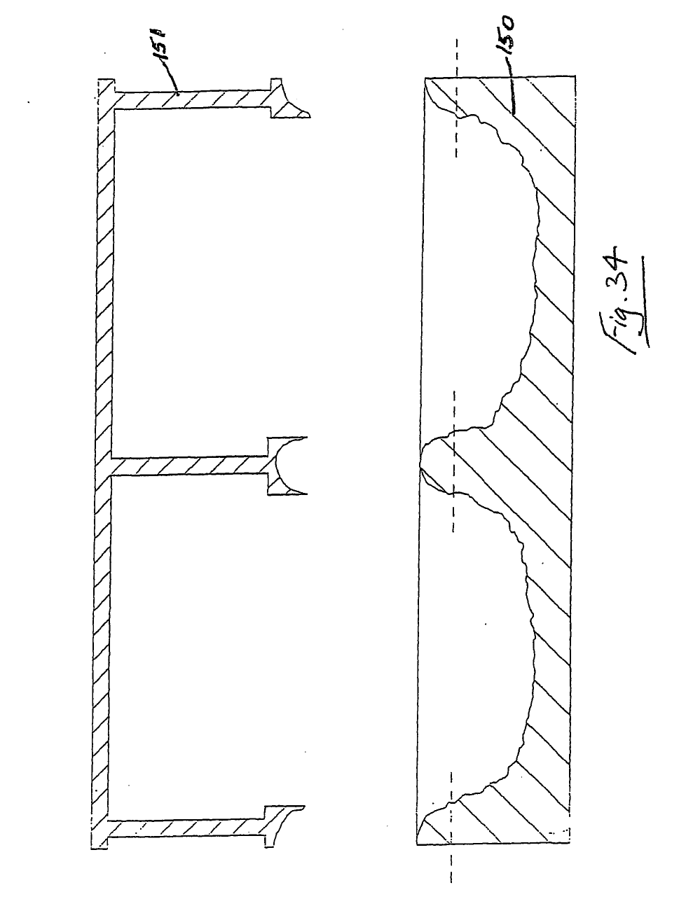

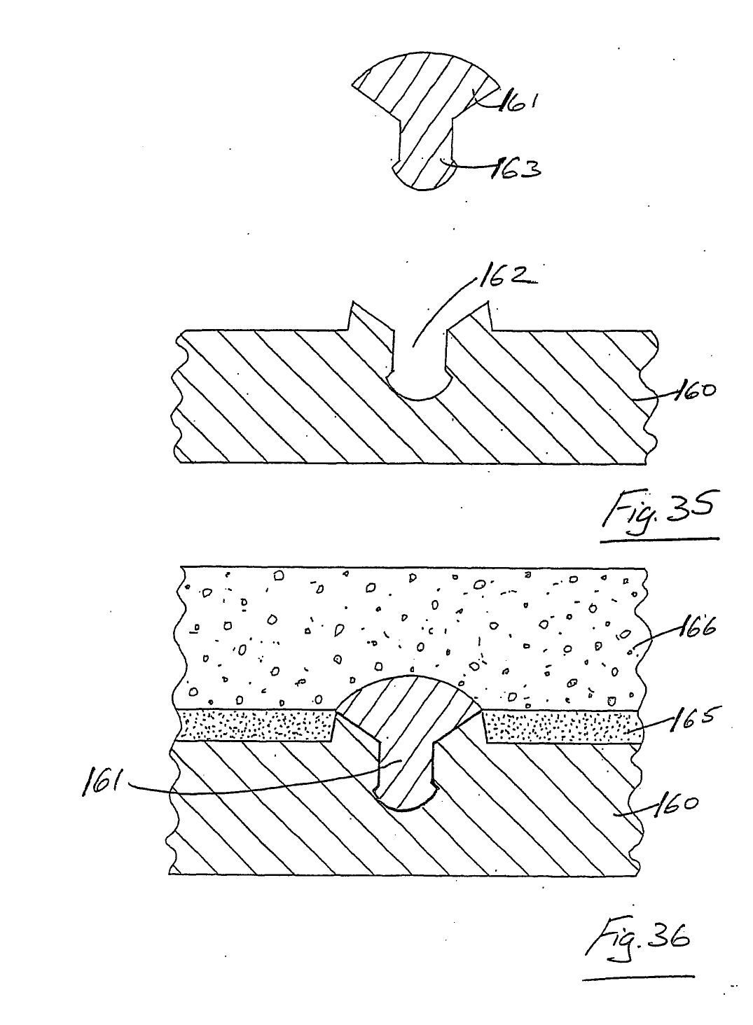

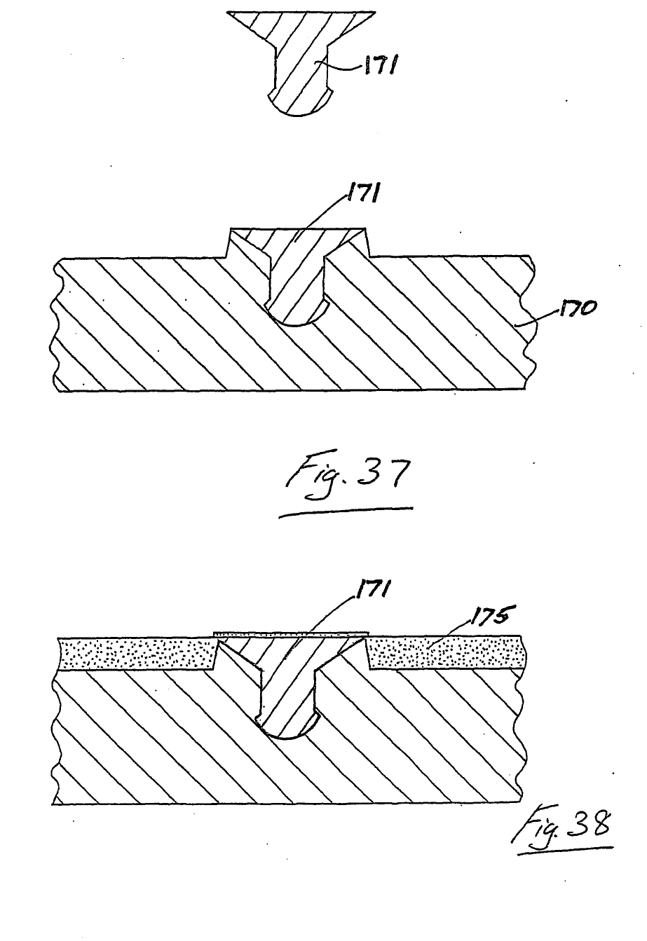

Referring to FIGS. 29 to 33 the constructional element may be manufactured using an apparatus as illustrated in FIG. 29 and comprising a mould box 110, a mould mat 111, an insert grid 113 and a positioning tool 112 for holding the insert grid 113 in position during casting. The insert grid 113 defines the desired artificial mortar joints which are visible on de-moulding and removal of the insert grid 113.

The mould mat 111 comprises a grid which defines a plurality of recesses 120 therebetween. In general, the upper face, in use, of the mat grid is planar.

The insert grid 113 which may be referred to as a mortar mould has a curlinear upper surface to define the mortar joints.

In use, the mould mat 111 is placed flat on a support surface. A pourable brick or other facing mix is then poured into the recesses 120 of the mat 111. Vibration is used to remove bubbles and excess material. The upper faces of the mat 11 are then scraped-off, if necessary, to clean the surface and remove excess facing material. Alternatively the flat tops of the mould mat may be temporarily masked while the brick mix is being poured. This facilitates a thicker layer of brick mix being loaded into the mould. The mould box 110 is placed around the mat 111 and the mortar mould 113 is placed over the mat 111 with the curlinear faces uppermost. The positioning tool 112 is then inserted to engage the mortar mould 113. Concrete backing to a desired thickness is poured into the mould box 110 on top of the mortar mould 113. Vibration is used to remove bubbles from the poured concrete. On setting, the constructional element thus formed is de-moulded by inverting the mould box 110, removing the box 110, stripping off the mould mat 111 and finally stripping off the mortar mould 113 to reveal the cast element.

The invention enables the mass production of pointed masonry walling, paving and the like to be achieved by making, straight from a mould, a perfect imitation of a mortared joint.

It will be noted that mould mat 111 has depressions which form the finished brick/stone face and sidewalls which form the small projections of the finished brick/stone face. Typically the mould mat 111 is cast against pointed masonry to form an exact facsimile. Prior to the mould mat 111 being cast, the mortar mould 113 is cast into the recessed mortar joints so that the mould mat is cast against masonry and the flat top of the in-situ mortar mould 113. The mortar mould 113 does not completely fill the recessed mortared joints, but allows a small distance usually between 1 to 5 mm for the sidewalls of the mould mat 111 to be formed.

Thus, the recess depth in recessed pointing is used to form the mortar mould 113. The small projection often found in pointed masonry of the brick/stone from the recessed mortar joint is also incorporated to give the thickness of the brick.

In more detail, in use the shallow depressions in the mould mat 111 are filled with a cementitious substance having an aggregate size no larger than the depth of the recesses 120. This mixture is suitably coloured to imitate the desired effect, typically of brick or stone. The mixture is then vibrated to remove air bubbles from the face of the casting and also to remove excess cementitious material. The upper surface of the sidewalls of the mould mat 111 can, if necessary be further cleaned using a straight rule-like instrument, used with a scraping action. The mould box 110 is then placed over the mould mat 111. The mortar mould 113 is placed on top of the mould mat 111 whereby the flat bottom of the mortar mould 113 engages with the flat tops of the sidewalls of the mould mat 111.

The mortar mould positioning tool 112 is then pressed down onto the mortar mould 113 in order to stop the mortar mould 113 from moving in relation to the mould mat 111 when the backing concrete is being poured and the whole assembly further vibrated. The colour of the backing concrete will determine the colour of the imitation pointing mortar.

The mortar mould positioning tool 112 is then removed and the casting allowed to cure. When the mould mat 111 is peeled from the casting, brick/stone work will appear with the mortar mould 113 covering the joints. When the mortar mould 113 is removed, a perfect imitation of the original mortared joints is revealed.

The mortar mould 113 could also be held in position by adhesive or magnetism. The positioning tool 112 could also engage onto a rigid mesh cage-like structure, which in turn engages with the mortar mould. The mesh may itself provide the positioning tool. Alternatively a spring loaded mesh cage-like structure could be used. This structure could be left in situ, within the casting, to avoid damage during removal. It might in that instance act as a reinforcing member. The invention can be used to produce a two or more faced casting by increasing the number of mould mat/mortar moulds within the mould box. Mitred corner joints may be provided.

Referring to FIG. 34 there is illustrated an apparatus and a method for producing a stone-like effect with mortared joints. The joints can be recessed, flush or raised. In this instance a masking tool 150 is pressed against a mould mat 151, covering the areas which would correspond to the mortar on the original masonry master. Concrete retarder is then applied for example by spray or brush to the remaining surface of the mould mat, which would correspond to the stone on the original master. The masking tool 150 is removed, the retarder allowed to dry, the mould mat placed in a mould box and a concrete casting produced. When the casting cures its face is sprayed with water to remove the thin uncured layer of material from the casting, caused by the action of the retarder, thus exposing the aggregate within the concrete to give a close semblance of natural stone or the like.

The masking tool 151 prevents any retarder from contacting any mortar areas of the mould mat and consequently the joints take the colour appearance out of the concrete and become indistinguishable from a more conventional mortared joint. It is also possible to produce a concrete casting using the same mould mat, engage a masking assembly and then apply a retarder/etcher suitable for use on cured concrete over the area of the casting meant to imitate stone and the like. A stone-like effect is produced where the retarder etcher has come into contact with the casting but also leaves the “mortar” effect where the masking assembly has covered the concrete. Alternatively the face can be pressure sprayed with water or sand blasted instead of using a retarder/etching.

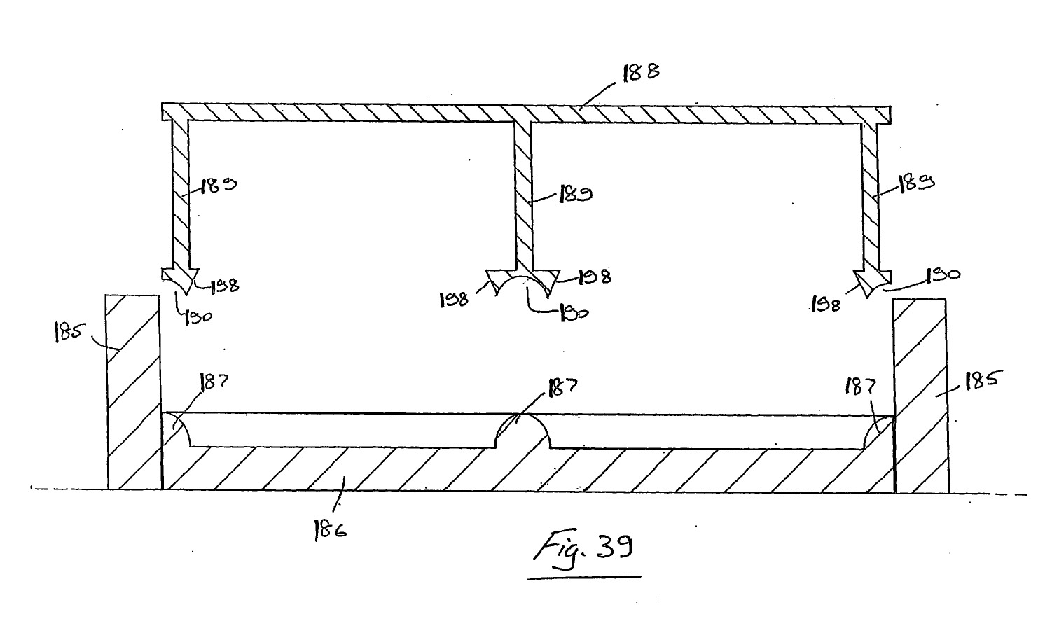

Referring to FIGS. 35 and 36 there is illustrated another mould mat 160 and associated mortar mat 161. In this case means are provided for securing the mortar mat 161 to the mould mat 160. The securing means comprises a female groove 162 on the mould mat 160 and an associated male projection 163 on the mortar mat 161, the groove 162 and projection 163 engaging on assembly as illustrated in FIG. 35. In FIG. 35 a facing material 165 and a backing material 166 are also shown. The arrangement is similar to that described above with reference to FIGS. 29 to 33.

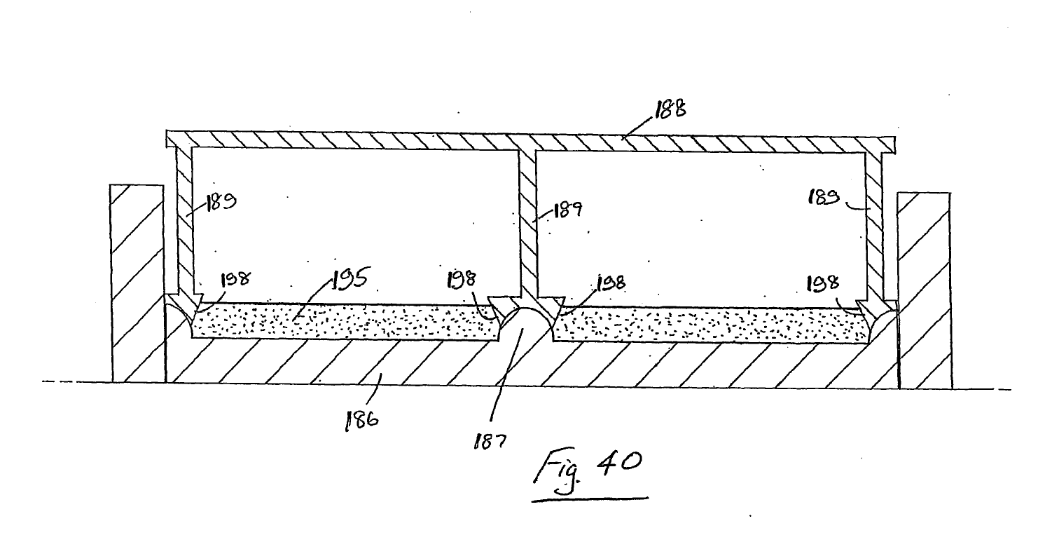

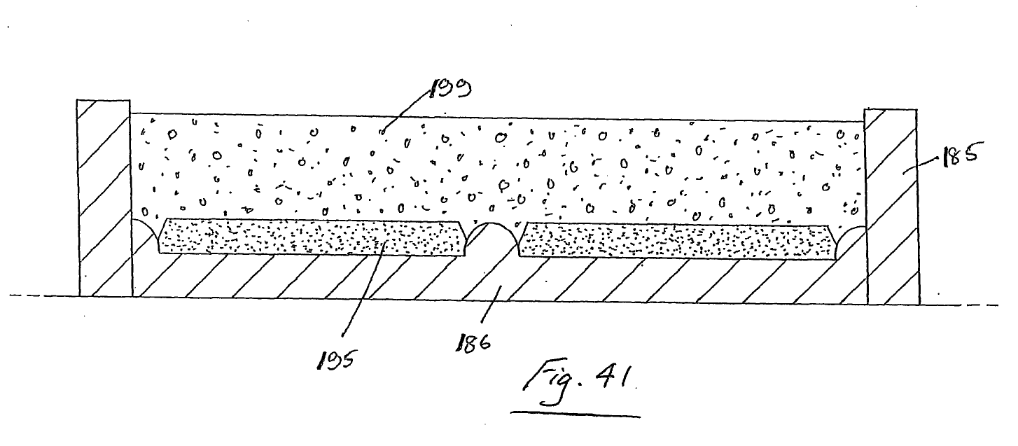

Referring to FIGS. 37 and 38 there is illustrated a mould mat 170 and a mortar mould channel mask 171 for masking a channel in the mould mat 170. The mat 170 and mask 171 have corresponding shaped grooves and projections for interengagement on assembly. A facing mix 175 on the mould mat 170 is vibrated, the channel mask 171 is removed and replaced by a mortar mould for further processing as described above.

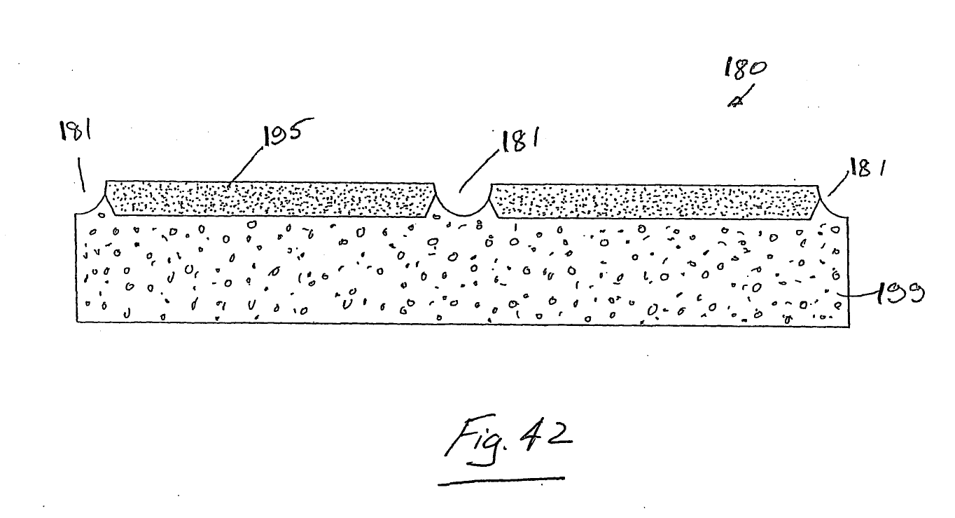

Referring to FIGS. 39 to 43 there is illustrated various steps in a method for casting a block 180 with cast-in grooves 181 and rebates giving a pointed masonry effect. Referring to FIG. 39 a mould comprises side walls 185 surrounding a mould mat 186 with upwardly projecting rounded ribs 187. A masking tool 188 has depending legs 189 with grooves 190 corresponding to the ribs 187 of the mortar mat 186. The arrangement provides a means for separating backing material from face material. In FIG. 40 the masking tool 188 is in position and a facing material 195 has been poured into the mortar mat 186. It will be noted that the depending legs 189 of the masking tool have angled faces 198 which assist in ease of removal of the masking tool 188. As the facing material is vibrated in the mould air bubbles are removed from the finished surface and the facing material rises up the angled faces 198 of the masking tool 188. The resultant face casting is less liable to be damaged or deformed when the backing mix is poured.

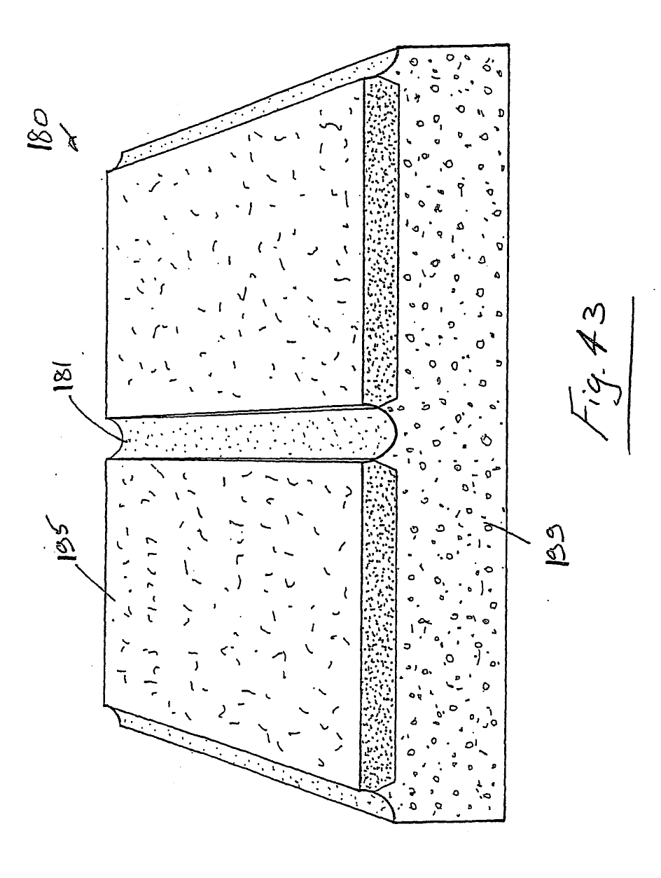

Referring to FIG. 41, following removal of the masking tool 188 a backing/mortar mix 199 is poured into the mould on top of the facing material 195 and the mould is again vibrated. A brick effect is generated by the facing material 195 and a mortar effect is created by the grooves 181 which are left in the facing material 195 on removal of the mould mat 186. The mortared joint can be recessed as shown in FIGS. 42 and 43, raised or flush.

Many variations on the invention will be readily apparent and accordingly the invention is not limited to the embodiment heretofore described, which may be varied in detail.

1. A method for manufacturing a constructional panel comprising the steps of:
providing a mould mat comprising a plurality of raised ribs, the ribs defining recesses therebetween and the raised ribs having upper surface contours;
placing a mask on the mould mat ribs to substantially cover at least the upper surface of the ribs;
casting a cementitious material in the mould; and
removing the cast panel thus formed from the mould.

2. A method as claimed in claim 1 comprising the step of:
applying a force to substantially seal the mask to the upper surface of the ribs.

3. A method as claimed in claim 1 wherein the force is a pressure force.

4. A method as claimed in claim 2 wherein the force is a magnetic force.

5. A method as claimed in claim 4 wherein the mould mat and/or the mask are at least partially magnetised.

6. A method as claimed in claim 5 wherein the mould mat and the mask are at least partially of a magnetic material.

7. A method as claimed in claim 1 comprising applying a retarder to the mould mat, prior to casting a cementitions material in the mould.

8. A method as claimed in claim 7 wherein the retarder is removed from the face of the panel, after casting.

9. A method as claimed in claim 8 wherein the retarder is removed by washing.

10. A method as claimed in claim 1 comprising casting a facing material in the recesses of the mould mat prior to casting the cementitions material.

11. A method as claimed in claim 10 wherein the facing material is a brick or brick-like material.

12. A method as claimed in claim 10 wherein the facing material is of a cementitious material.

13. A method as claimed in claim 10 wherein the facing material includes a colouring agent.

14. A method as claimed in claim 1 comprising the step of removing the mask prior to casting of the cementitious material.

15. A method as claimed in claim 7 comprising removing the mask after application of the retarder.

16. A method as claimed in claim 10 comprising removing the mask after casting of the facing material.

17. A method as claimed in claim 1 wherein the mask comprises a masking tool.

18. A method as claimed in any of claim 1 wherein the mask comprises a grid.

19. A method as claimed in claim 1 wherein the mould mat is manufactured by:
providing a mould box;
building a panel comprising a plurality of elements with joints therebetween in the mould;
applying a mould-forming material over the exposed face of the panel thus formed to form a mould mat; and
removing the mould mat from the mould, the mould mat having a plurality of ribs with an upper surface contour corresponding to the contour of the joints of the panel built in the mould box.

20. A method as claimed in claim 19 wherein the mask is manufactured by:
applying a mask-forming material over the ribs of the mould mat; and
removing the mask from the ribs.

21. A method as claimed in claim 20 wherein the mask is formed from a flowable material.

22. A method as claimed in claim 21 wherein the mask is formed by:
providing damming means around the ribs;
pouring the mask-forming material onto the ribs;
setting the mask-forming material;
removing the damming means; and
removing the formed mask from the ribs.

23. A method for casting a cementitious constructional elements with a facing comprising the steps of:
placing a mould mat in a mould, the mould mat comprising a grid defining a plurality of recesses therebetween;
casting a facing material in the recesses of the moult mat;
casting a cementitious material to a desired thickness on top of the cast facing material; and p1 removing the cast panel thus formed from the mould.

24. A method as claimed in claim 23 comprising the step after casting of the facing and prior to casting of the cementitious material, of placing an insert grid over the grid pattern of the mould mat.

25. A method as claimed in claim 24 wherein the insert grid is shaped to form recessed mortar joints in the cementitious material.

26. A method as claimed in claim 23 wherein the method includes the step of applying a retaining force to the insert grid to retain the retaining grid in a desired position during casting of the cementitious material.

27. A method as claimed in claim 26 wherein the retaining force is applied by a spring bias from the retaining grid/cage.

28. A method as claimed in claim 26 wherein the retaining force is applied by a positioning tool.

29. A method as claimed in claim 28 wherein the method includes the step of inserting the positioning tool into the mould to engage the insert grid and retain the grid in position during casting of the cementitious material.

30. A method as claimed in claim 24 wherein the facing material is a brick or brick-like material.

31. A method as claimed in claim 24 wherein the facing material is a cementitious material.

32. A method as claimed in claim 30 wherein the facing material may include a colouring agent.

33. A method as claimed in claim 24 comprising inserting a masking tool to engage the grid pattern of the mould mat and withdrawing the masking tool prior to casting of the cementitious material.

34. A method for producing a stone-like effect with mortared joints comprising pressing a masking tool against a mould mat to cover the areas which would correspond to mortared joints, and applying a retarder.

35. A method as claimed in claim 34 comprises removing the masking tool to the remaining surface of the mould mat.

36. A method as claimed in claim 35 comprising placing the mould mat in a mould box to produce a casting, typically of a cementitious material.

37. A method as claimed in claim 36 comprising a box to produce a casting, typically of a cementitious material after curing, of applying water to the face of the casting to expose the aggegate of the cementitious material.

38. A method for manufacturing a mask for use in moulding a constructional panel comprising:
providing a mould mat having a plurality of ribs with an upper surface contour corresponding to the contour of jointing between constructional elements;
applying a mask-forming material onto the ribs of the mould mat; and
removing the mask from the ribs.

39. A method as claimed in claim 38 wherein the mask is formed from a flowable material.

40. A method as claimed in claim 39 wherein the mask is formed by:
providing damming means around the ribs;
pouring the mask-forming material onto the ribs;
setting the mask-forming material;
removing the damming means; and
removing the formed mask from the ribs.

41. A cast panel comprising a plurality of facing elements with a jointing between the facing elements, the panel having a defined interface between the facing elements and the jointing material and the panel being substantially of cementitious material.

42. A panel as claimed in claim 41 wherein the facing elements are of brick or brick-like material.

43. A panel as claimed in claim 41 wherein the facing elements are substantially of cementitious material.

44. A panel as claimed in claim 43 wherein the facing elements replicate a stone facing.
